(19) United States
(12) Patent Application Publication
(10) Pub. No.: US 2013/0068582 A1
(43) Pub. Date: Mar. 21, 2013

(54) SYNCHRONIZER SLEEVE AND MANUFACTURING METHOD THEREOF

(71) Applicants: Ki Jung Kim, Hwaseong (KR); Ki Bum Kim, Hwaseong (KR); Seong Jin Kim, Yongin (KR); Hyun Noh Kim, Yongin (KR); Shin Gyu Kim, Hwaseong (KR); Hyun Ki Kim, Yongin (KR)

(72) Inventors: Ki Jung Kim, Hwaseong (KR); Ki Bum Kim, Hwaseong (KR); Seong Jin Kim, Yongin (KR); Hyun Noh Kim, Yongin (KR); Shin Gyu Kim, Hwaseong (KR); Hyun Ki Kim, Yongin (KR)

(73) Assignees: Kia Motors Corporation, Seoul (KR); Hyundai Motor Company, Seoul (KR)

(21) Appl. No.: 13/323,544

(22) Filed: Dec. 12, 2011

(30) Foreign Application Priority Data
Sep. 21, 2011 (KR) 10-2011-0095032

(51) Int. Cl. F16D 23/14; B22F 3/24; B22F 3/10

(52) U.S. Cl. 192/53.3; 419/29

(57) ABSTRACT

The present invention provides a synchronizer sleeve and a manufacturing method thereof. The synchronizer sleeve is formed by powder metallurgy using a powder mixture having iron as a main ingredient, 0.2 to 0.3 wt % of carbon, 0.5 to 4.0 wt % of nickel, 0.2 to 2.0 wt % of molybdenum and other indispensable impurities.

### CROSS-REFERENCE TO RELATED APPLICATION

This application claims under 35 U.S.C. §119(a) the benefit of Korean Patent Application No. 10-2011-0095032 filed on Sep. 21, 2011 the entire contents of which are incorporated herein by reference.

### BACKGROUND

(a) Technical Field

The present disclosure relates to a synchronizer sleeve configured to engage with a clutch gear via a shift fork during a gear shift operation to transmit power from an engine to the gear and a method of manufacturing the synchronizer sleeve.

(b) Background Art

Generally, a vehicle is provided with a power transmission system to transmit power from an engine to wheels. As shown in FIG. 1, a synchromesh mechanism of a manual transmission includes a synchronizer hub 20 spline-coupled to a shaft (not shown), a sleeve 10 spline-coupled to an outer circumference of a clutch hub, a gearshift rotatably coupled to the shaft, a clutch gear 40 formed on a conical portion of the gearshift to engage with the sleeve, a synchronizer ring coupled to the conical portion of the gearshift to perform a clutch function when making contact with the conical portion by the movement of the sleeve, and a key fitted into a recess of the clutch hub, biased towards the inner surface of the sleeve by an extending force of a synchronizer spring (not shown) and inserted into a recess of the synchronizer ring as the sleeve moves. Such a synchronizing device engages with the clutch gear of the gearshift rotating at a shaft speed by the movement of the sleeve, thus transmitting a rotating force from the transmission to the shaft.

Here, the synchronizer sleeve 10 engages with the clutch gear via a shift fork during a gear shift operation, thus transmitting power from an engine to the gear. The synchronizer sleeve 10 is generally manufactured via a complicated manufacturing processes, for example, forging, lathe turning, rough broaching, reverse tapering, spline-end chamfering, finish broaching, carburizing and high-frequency heat treatment. Such a method is expensive because of its complicated process, and thermal deformation may be dangerous during the carburizing and heat treatment because of a processing load especially in the broaching process. Thus, an object of the present invention is to simplify a manufacturing method of the synchronizer sleeve 10 through powder metallurgy, thus reducing a manufacturing cost.

The foregoing is designed merely to aid in the understanding of the background of the present invention, and is not intended to mean that the present invention falls within the purview of the related art that is already known to those of ordinary skill in the art.

### SUMMARY OF THE DISCLOSURE

The present invention has been made in an effort to solve the above-described problems associated with prior art. An object of the present invention is to provide a synchronizer sleeve and a method of manufacturing the synchronizer sleeve, intended to simplify a manufacturing process through powder metallurgy, thus achieving a reduction in manufacturing costs.

In one aspect, the present invention provides a synchronizer sleeve formed by powder metallurgy using a powder mixture containing iron as a main ingredient, 0.2 to 0.3 wt % of carbon, 0.5 to 4.0 wt % of nickel, 0.2 to 2.0 wt % of molybdenum and other indispensable impurities. Preferably, the synchronizer sleeve may have a density of 7.3 g/cc or more.

In some embodiments, the synchronizer sleeve may form a spline along an outer circumference or an inner circumference thereof, and a chamfer may be formed on an upper end or a lower end of the spline, the chamfer being formed together with a base material by powder metallurgy. Preferably, the chamfer may have a radius of about 0.2 to 0.5 mm.

In another aspect, the present invention provides a method of manufacturing a synchronizer sleeve, comprising a) mixing metal powders to contain iron as a main ingredient, 0.2 to 0.3 wt % of carbon, 0.5 to 4.0 wt % of nickel, 0.2 to 2.0 wt % of molybdenum and other indispensable impurities; b) forming a powder mixture by powder metallurgy; and c) finishing a formed product by sintering and heat treatment. Preferably, the formed product may be sintered for 30 minutes to 2 hours in a reducing atmosphere of 1100 to 1300° C.

In some embodiments, while forming the powder mixture by powder metallurgy, a spline may be formed along an outer circumference or an inner circumference of the synchronizer sleeve, the spline being chamfered at an upper or lower end thereof. Alternatively or additionally, a spline may be formed along an outer circumference of the synchronizer sleeve, the formed spline being trimmed by rolling.

Other aspects and preferred embodiments of the invention are discussed below.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is an exploded perspective view showing a power transmission system including a conventional synchronizer sleeve;

FIG. 2 is a view showing a synchronizer sleeve in accordance with an exemplary embodiment of the present invention; and

FIG. 3 is a partially enlarged view showing the synchronizer sleeve of FIG. 2.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A synchronizer sleeve and a manufacturing method thereof according to an exemplary embodiment of the present invention will be described below with reference to the accompanying drawings.

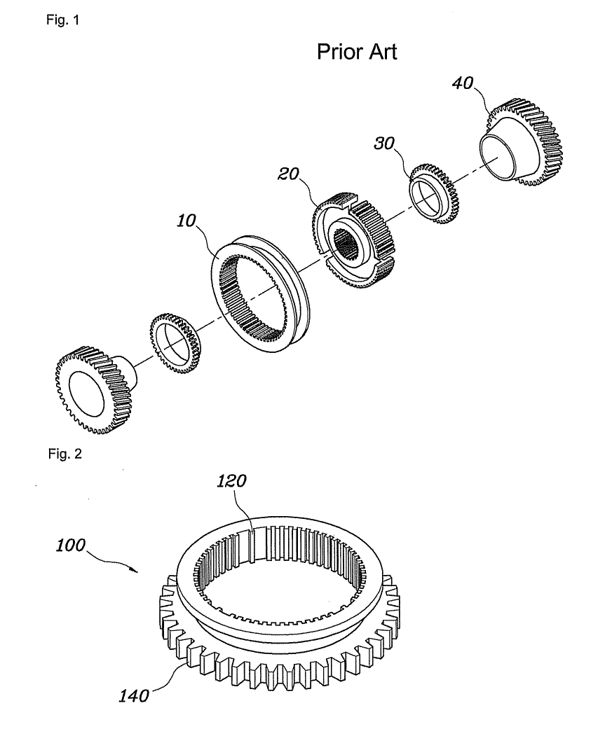

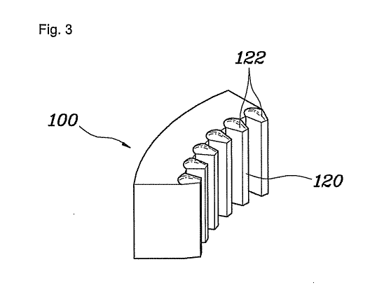

FIG. 2 is a view showing a synchronizer sleeve in accordance with an embodiment of the present invention, and FIG. 3 is a partially enlarged view showing the synchronizer sleeve of FIG. 2. According to the present invention, a synchronizer sleeve is formed by powder metallurgy using a powder mixture containing iron (Fe) as a main ingredient, 0.2 to 0.3 wt % of carbon (C), 0.5 to 4.0 wt % of nickel (Ni), 0.2 to 2.0 wt % of molybdenum (Mo) and other indispensable impurities.

Further, the synchronizer sleeve may have a density of 7.3 g/cc or more. The synchronizer sleeve may form a spline along an outer circumference or an inner circumference thereof, and a chamfer may be formed on an upper end or a lower end of the spline and formed together with a base material by powder metallurgy. The chamfer may have a radius of 0.2 to 0.5 mm.

Further, a method of manufacturing a synchronizer sleeve according to the present invention includes the step of mixing metal powders to contain iron (Fe) as a main ingredient, 0.2 to 0.3 wt % of carbon (C), 0.5 to 4.0 wt % of nickel (Ni), 0.2 to 2.0 wt % of molybdenum (Mo) and other indispensable impurities, the step of forming a powder mixture by powder metallurgy, the step of finishing a formed product by sintering and heat treatment. At the finishing step, the formed product may be sintered for 30 minutes to 2 hours in a reducing atmosphere of 1100° C. to 1300° C.

Additionally, while forming the powder mixture by powder metallurgy, a spline may be formed along an outer circumference or an inner circumference of the synchronizer sleeve and chamfered at an upper or lower end thereof. Further, a spline may also or alternatively be formed along an outer circumference of the synchronizer sleeve, and the formed spline may be trimmed by rolling.

The method of manufacturing the synchronizer sleeve according to the present invention includes the powder-alloy mixing step, the mixed-powder forming step, the formed-product sintering step, the sintered-product sizing step, and the step of processing and heat treating the sintered product.

To be more specific, alloy powder composed of 0.5 to 4.0 wt % of nickel (Ni), 0.2 to 2.0 wt % of molybdenum (Mo), iron (Fe), and 0.2 to 0.3 wt % of carbon is prepared to produce a powder alloy mixture during mixing of the metal powders. If the nickel is 0.5 wt % or less, the mechanical properties of a material may be deteriorated. Meanwhile, if the nickel is 4.0 wt % or more, a material cost may be increased. If the molybdenum (Mo) is 0.2 wt % or less, hardenability achieved by heat treatment may be deteriorated. Meanwhile, if the molybdenum is 2.0 wt % or more, a material cost may be increased and formability may be deteriorated. Further, if the carbon is 0.2 wt % or less, the density of a deep part may be reduced during heat treatment. Meanwhile, if the carbon is 0.3 wt % or more, shock resistance may be deteriorated by brittleness after heat treatment.

The powder alloy mixture is formed as the formed product having the shape of an inner spline 120 during the forming step. At this time, a spline end 122 may be chamfered as shown in FIG. 3 to eliminate a post process in the manufacturing. An end of the chamfered portion may be rounded to have a radius of 0.2 to 0.5 mm. If the radius is 0.2 mm or less, a mold may be damaged. In contrast, if the radius is 0.5 mm or more, synchronous engagement is disadvantageous during an operation.

In the case of requiring a spur gear 140 on an outer portion, a toothed shape may be provided to the mold during forming, and rolling may be used to enhance tooth precision and strength.

Meanwhile, in order to accomplish the object of the present invention, the formed product would preferably have a high density of 7.3 g/cc or more. The formed product goes through a sintering process at 1100° C. to 1300° C. for 30 minutes to 2 hours in a reducing atmosphere. If a sintering temperature is 1100° C. or less, substance dispersion between powders and necking are not smoothly conducted. Meanwhile, when the sintering temperature is 1300° C. or more, mass productivity is considerably reduced. Additionally when the sintering time is 30 minutes or less, substance dispersion between powders and necking are not smoothly conducted. Meanwhile, when the sintering time is 2 hours or more, mass productivity is greatly reduced.

In order to correct thermal deformation during the sintering process, a sizing process is additionally performed. After the sintering process has been performed, the inner spline goes through reverse tapering, chamfering and milling. Thereafter, carburizing and heat treatment are performed.

As an embodiment of this invention, a strength test for a material applied to this invention is conducted. As a comparative example compared with the embodiment, Cr-based alloy steel (SCR420H) used as a material for the exiting process including forging is manufactured as a tensile specimen to be evaluated.

According to this embodiment, 0.5 wt % of Ni, 0.5 wt % of Mo, 0.2 wt % of C, and Fe powders are mixed to form a product with the density of 7.35 g/cc, and then the sintering process is performed for 30 minutes in a reducing atmosphere with 90% N2 and 10% H2. Carburizing and heat treatment are performed as follows: after carburizing is conducted at 900° C. for 60 minutes+850° C. for 30 minutes under the condition that Cp (carbon potential) is 0.8%, oil cooling is performed at 90° C., and tempering is performed at 150° C. for 2 hours. According to the test results shown in the following table 1, the embodiment has the yield strength of 1,006 MPa, which is similar to 1,051 MPa of the comparative example, thus realizing similar high strength properties as that of comparative example.

TABLE 1

| | | | | | Effective |
|---|---|---|---|---|---|
| | | Yield | | Surface | Case |
| | Density | strength | Elongation | Hardness | Depth |
| Item | (g/cm³) | (MPa) | (%) | (HV 0.3 kgf) | (mm) |
| Embodiment | 7.35 | 1006 | 0.92 | 728 | 0.58 |
| Comparative | 7.81 | 1051 | 1.19 | 749 | 0.51 |
| Example | | | | | |

In order to test the durability of the synchronizer sleeve, the test for torsional rupture/fatigue test and transmission durability is performed. According to this embodiment, the forming is conducted using the mold that is made to provide the radius of 0.3 mm to the end of the chamfer. The torsional rupture/fatigue test is performed with the synchronizer sleeve of this embodiment, which is compared with the forged/processed material of the comparative example. The test method and results are shown in the following table 2.

In the case of performing the torsion test, fixed torsion torque is applied to the inner spline of the sleeve by 50% from both jigs. In the case of performing the torsional rupture test, torque is applied at the speed of 0.5°/min to measure strength when rupturing. In the case of performing the torsional fatigue test, a load of 13.6 to 136 Nm on the basis of 156 Nm that is an operating torque condition is applied in the form of a sine wave at the speed of 10 Hz.

TABLE 2

| Item | | Numbers of Test | Test Result |
|---|---|---|---|
| Torsional | Comparative | 1 | 482 |
| Rupture | Example | 2 | 459 |
| | | 3 | 463 |
| | Embodiment | 1 | 421 |
| | | 2 | 409 |
| | | 3 | 425 |
| Torsional | Comparative | 1 | O.K. |
| Fatigue | Example | | (No damage, abrasion) |
| (@ 136 Nm, 1 | | 2 | O.K. |
| million times) | | | (No damage, abrasion) |
| | | 3 | O.K. |
| | | | (No damage, abrasion) |
| | Embodiment | 1 | O.K. |
| | | | (No damage, abrasion) |
| | | 2 | O.K. |
| | | | (No damage, abrasion) |
| | | 3 | O.K. |
| | | | (No damage, abrasion) |

According to the test results, the torsional rupture torque of this embodiment is 418 Nm, whereas that of the comparative example is 468 Nm, so that this embodiment is inferior to the comparative example. However, even when stress is applied one million times under the durable torque condition of the transmission, 136 Nm, this embodiment shows good durability much like the comparative example. Therefore, this retains mechanical properties similar to those of the existing alloy steel produced by forging/machining. The present invention reduces broaching by at least two times and eliminates the chamfering process for the spline end in comparison with the existing method, thus achieving a reduction in cost of the manufacturing method.

As described above, the present invention provides a synchronizer sleeve and a manufacturing method thereof, in which a manufacturing process is simplified through powder metallurgy, thus achieving a reduction in manufacturing cost. Further, the present invention provides a synchronizer sleeve and a manufacturing method thereof, in which a complicated process is omitted, so that a manufacturing period is shortened, and while at the same time providing a synchronizer sleeve with the required performance.

Meanwhile, the present invention provides a synchronizer sleeve and a manufacturing method thereof, in which the synchronizer sleeve is formed, sintered, sized and heat treated using the material of nickel, molybdenum, and iron powder, so that a finished product maintains a density of 7.3 g/cc or more, is inexpensive, and retains mechanical properties similar to those when using an existing alloy steel forging and machining method. The present invention reduces broaching by at least twice and eliminates the spline-end chamfering process as compared to the existing method, thus achieves a reduction in manufacturing costs.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A synchronizer sleeve formed by powder metallurgy using a powder mixture comprising iron as a main ingredient, 0.2 to 0.3 wt % of carbon, 0.5 to 4.0 wt % of nickel, 0.2 to 2.0 wt % of molybdenum and other indispensable impurities.

2. The synchronizer sleeve of claim 1, wherein the synchronizer sleeve has a density of 7.3 g/cc or more.

3. The synchronizer sleeve of claim 1, wherein the synchronizer sleeve forms a spline along an outer circumference or an inner circumference thereof, and a chamfer is formed on an upper end or a lower end of the spline, the chamfer being formed together with a base material via powder metallurgy.

4. The synchronizer sleeve of claim 1, wherein the chamfer has a radius of 0.2 to 0.5 mm.

5. A method of manufacturing a synchronizer sleeve, comprising:
a) mixing metal powders having iron as a main ingredient, 0.2 to 0.3 wt % of carbon, 0.5 to 4.0 wt % of nickel, 0.2 to 2.0 wt % of molybdenum and other indispensable impurities;
b) forming a powder mixture by powder metallurgy; and
c) finishing a formed product by sintering and heat treatment.

6. The method of claim 5, wherein, at c), the formed product is sintered for 30 minutes to 2 hours in a reducing atmosphere of 1100° C. to 1300° C.

7. The method of claim 5, wherein, at b), a spline is formed along an outer circumference or an inner circumference of the synchronizer sleeve, the spline being chamfered at an upper or lower end thereof.

8. The method of claim 5, wherein, at b), a spline is formed along an outer circumference of the synchronizer sleeve, the formed spline being trimmed by rolling.
